(19) United States
(12) Patent Application Publication
(10) Pub. No.: US 2007/0086179 A1
(43) Pub. Date: Apr. 19, 2007

(54) Light mixing plate and direct backlight module

(75) Inventors: Wei Hsuan Chen, Kaohsiung (TW); Yi Fang Lin, Kaohsiung (TW)

Correspondence Address: LEONG C LEI, PMB # 1008, 1867 YGNACIO VALLEY ROAD, WALNUT CREEK, CA, 94598, US

(73) Assignee: RADIANT OPTO-ELECTRONICS CORPORATION

(21) Appl. No.: 11/249,443

(22) Filed: Oct. 14, 2005

(51) Int. Cl. G01D 11/28

(52) U.S. Cl. 362/27; 362/97; 362/613; 362/612; 362/621

(57) ABSTRACT

A novel light mixing plate and a direct backlight module using the light mixing plate are provided herein. The light mixing plate has a first surface and a second surface, in which a number of indented grooves are configured along the first surface to accommodate the LED light sources. The lights from the LEDs enter the light mixing plate via the side walls of the grooves and propagate an extended distance inside the light mixing plate so that they are fully mixed with each other into a uniform planar white light when leaving the light mixing plate via the second surface.

### BACKGROUND OF THE INVENTION

(a) Technical Field of the Invention

The present invention generally relates to backlight modules and, more particularly, to a light mixing plate and a backlight module utilizing the light mixing plate.

(b) Description of the Prior Art

Currently, most large-sized liquid crystal displays (LCDs), such as LCD monitors, LCD TVs, etc., adopt a direct backlight module. As illustrated in FIG. 1, a conventional direct backlight module mainly contains a number of light source units 12 positioned inside a casing 11, a diffusion plate 13, and one or more optical sheets 14.

The inner surface of the casing 11 is coated with a reflection film 11, or is processed to reflect lights from the light source units 12.

Usually, cold cathode fluorescent lamps (CCFLs) are used as the light source units 12, which are arranged uniformly inside the casing 11.

The diffusion plate 13 is positioned in front of the light source units 12 along the path of lights from the light source units 12, and covers the opening of the casing 11. The optical sheets 14 are then positioned behind the diffusion plate 13.

The optical sheets 14 could contain one ore more diffusion sheet 141 and prism sheets 142. The number of diffusion and prism sheets 141 and 142, and their relative positions, could be adjusted based on the application requirement.

A portion of the lights from the light source units 12 propagate directly to the diffusion plate 13, while the rest of the lights are reflected by the casing 11 and then directed to the diffusion plate 13. The diffusion plate 13 is usually embedded with diffusion beads to scatter lights from the light source units 12 to various directions so that uniform lights are provided to the LCD panel A. If the uniformity of lights from the diffusion plate 13 is less than adequate, additional diffusion and scattering is provided by the diffusion sheet 141, and the prism sheet 142 is used to focus the lights and thereby enhance the brightness of the backlight module.

The aforementioned direct backlight module has been a quite mature technique in recent years. However, the mercury contained inside the CCFLs is considered a hazard to the environmental protection and is legally prohibited in the use of goods by many advanced countries. CCFL-based direct backlight modules are therefore gradually replaced by direct backlight modules using light emitting diodes (LEDs) as the light source units. As illustrated in FIG. 2, a LED-based direct backlight module mainly contains a number of LEDs (i.e., light source units) 22 positioned inside a casing 21, a light mixing plate 23, a diffusion plate 24, and one or more optical sheets 25. The inner surface of the casing 11 is coated with a reflection film 211, or is processed to reflect lights from the LEDs 22.

Usually, LEDs 22 contains red-light (R) LEDs 221, green-light (G) LEDs 222, and blue-light (B) LEDs 223, and these LEDs are sequentially arranged in an array inside the casing 21.

The light mixing plate 23 is positioned in front of the LEDs 22 along the path of lights from the LEDs 22, and covers the opening of the casing 21. The light mixing plate 23 is made of a material having high transparency (such as PMMA). The light mixing plate 23 has a back surface 231 and a front surface 232 and, upon one of the back and front surfaces 231 and 232, a number of light shielding dots 233 are coated at locations corresponding to the LEDs 22. The light shielding dots 233 are made of a coating material that can significantly shield the lights from the LEDs 22.

The diffusion plate 24 and the optical sheets 25 are then positioned behind the light mixing plate 23. The optical sheets 25 could contain one ore more diffusion sheet 251 and prism sheets 252. The number of diffusion and prism sheets 251 and 252, and their relative positions, could be adjusted based on the application requirement.

Lights from the LEDs 22 are blocked by the light shielding dots 233 immediately in the front, and therefore a large of portion of the lights propagates along the inside of the light mixing plate 23. As such, the lights from the red-light LEDs 221, green-light LEDs 222, and blue-light LEDs 223 are mixed inside the light mixing plate to produce white lights. The produced white lights are then further scattered and uniformed by the diffusion plate 24 and the diffusion sheet 251. The white lights are then focused by the prism sheet 252 for brightness enhancement.

As shown in FIG. 3, as the LEDs 22 are positioned outside of the front surface 232, lights from the LEDs 22 are incident to front surface 232 at an angle. Even though a portion of the lights indeed propagates along the light mixing plate 23 and is thereby mixed, still a large portion of the non-mixed, red, green, and blue lights is directly refracted out of the back surface 231 if their incident angles to the back surface 231 are smaller than the threshold angle. This incomplete mixing phenomenon is resolved by lengthening the distance between the light mixing plate 23 and the diffusion plate 24 so that these non-mixed lights get a second chance to mix with each other as they propagate toward the diffusion plate 24. This inevitable makes the backlight module quite thick, which is not conforming to the market's requirement for slim LCDs.

To overcome the foregoing problem of LED-based direct backlight module, a technique illustrated in FIG. 4 has been disclosed. As shown, the backlight module similarly contains a number of LEDs 32 positioned inside a casing 31, a light mixing plate 33, a diffusion plate 34, and one or more optical sheets 35. The difference lies in that the LEDs 32 are configured as side-emitting LEDs. As shown in FIG. 5, each of the LEDs 32 has a reflection entity 321 in the shape of an inverted cone configured in the front, which reflects the lights from the LEDs 32 and thereby increases the lights' incident angles into the front surface 332 of the light mixing plate 33. This technique is effective but only to a limited extent. Still a large portion of the non-mixed lights from the LEDs 32 is refracted out of the back surface 331 and a certain distance between the light mixing plate 33 and the diffusion plate 34 therefore still has to be maintained.

Accordingly, how to reduce the thickness of environmentally friendly, LED-based, direct backlight modules is the major problem that the present invention is intended to solve.

### SUMMARY OF THE INVENTION

The primary purpose of the present invention is to provide a novel light mixing plate and a direct backlight module using the light mixing plate, so that lights from the LEDs can propagate farther along the light mixing plate and thereby achieve a far better mixing effect to provide a uniform planar light source for the target application.

To achieve the objective, the light mixing plate has a first surface and a second surface, in which a number of indented grooves are configured along the first surface for the accommodation of the LEDs. The lights from the LEDs are incident into the light mixing plate via the side walls of the grooves so that they can propagate for a farther distance and achieve a better mixing effect.

Another characteristic of the present invention is that a number of light guiding dots could be configured along the first surface to reflect lights toward the second surface. The reflection provides not only additional diffusing effect but also uniforming effect to the lights.

An additional characteristic of the present invention is that the second surface of the light mixing plate could be roughened to become a mat surface so that, when lights emitted out of the second surface, they are further scattered and uniformed.

Still another characteristic of the present invention is that a number of elongated V-shaped light guiding entities are configured along the first surface of the light mixing plate so as to reflect lights toward the second surface. The arrangement and density of elongated V-shaped light guiding entities are configured so as to control the energy distribution of lights of the backlight module.

Yet another characteristic of the present invention a number of elongated V-shaped light guiding entities are configured along the second surface of the light mixing plate so that lights emitted out of the light mixing pate are focused for enhanced brightness as they pass through the second surface.

Additionally, the V-shaped light guiding entities could be configured along both the first and the second surfaces, and the orientation of the V-shaped light guiding entities on these two surfaces are orthogonal to achieve multi-directional focusing and thereby an even better brightness.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic side view showing a conventional direct backlight module.

FIG. 2 is a schematic side view showing another conventional direct backlight module.

FIG. 3 is a schematic view showing the trajectories of lights of FIG. 2.

FIG. 4 is a schematic side view showing yet another conventional direct backlight module.

FIG. 5 is a schematic view showing the trajectories of lights of FIG. 4.

FIG. 6 is a perspective view showing a light mixing plate according to a first embodiment of the present invention.

FIG. 7 is a schematic view showing the trajectories of lights of FIG. 6.

FIG. 8 is a schematic view showing the trajectories of lights of FIG. 6 when using side-emitting LEDs.

FIGS. 9 and 10 are schematic views showing the trajectories of lights of FIG. 6 when using laterally arranged LEDs.

FIGS. 11˜13 are schematic side views showing various embodiments of the light guiding pattern according to the present invention.

FIG. 14 is a schematic side view showing an embodiment of the light mixing plate having a mat surface.

FIGS. 15˜18 are schematic views showing various embodiments of the present invention in which V-shaped light guiding entities are configured.

FIGS. 19 and 20 are schematic perspective views showing a light mixing plate according to a second embodiment of present invention.

FIG. 21 is a schematic side view showing a direct backlight module using a light mixing plate according to the present invention.

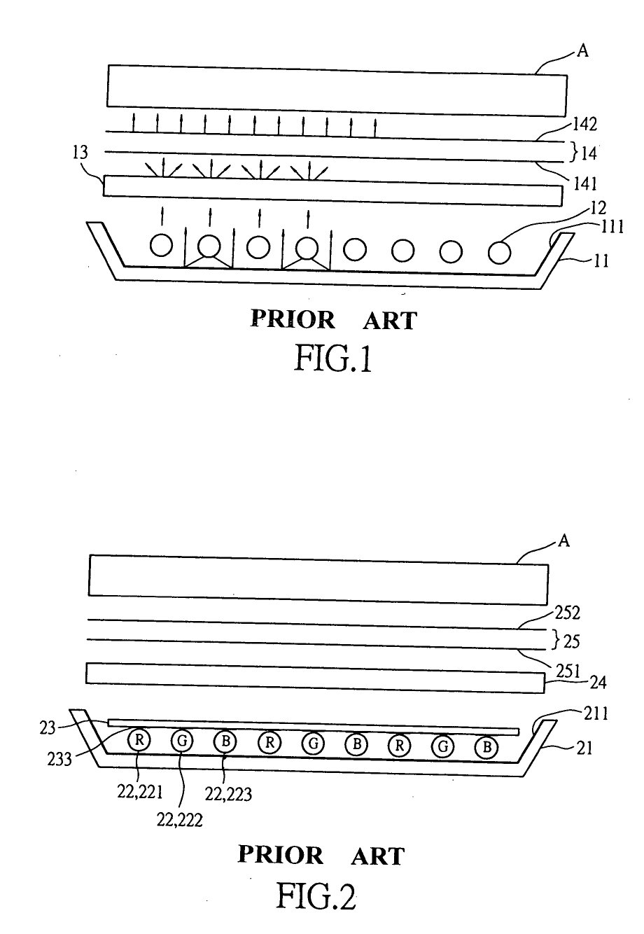

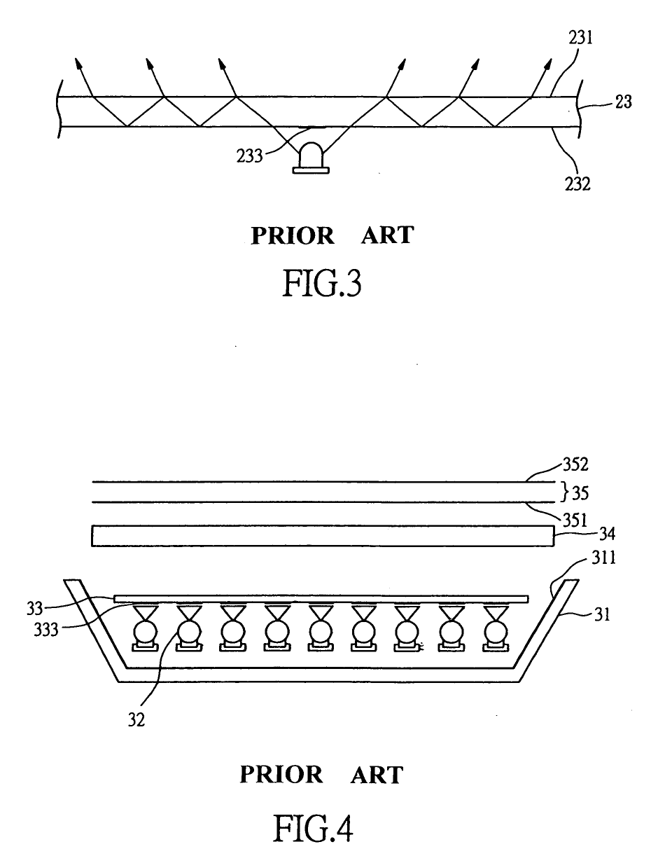

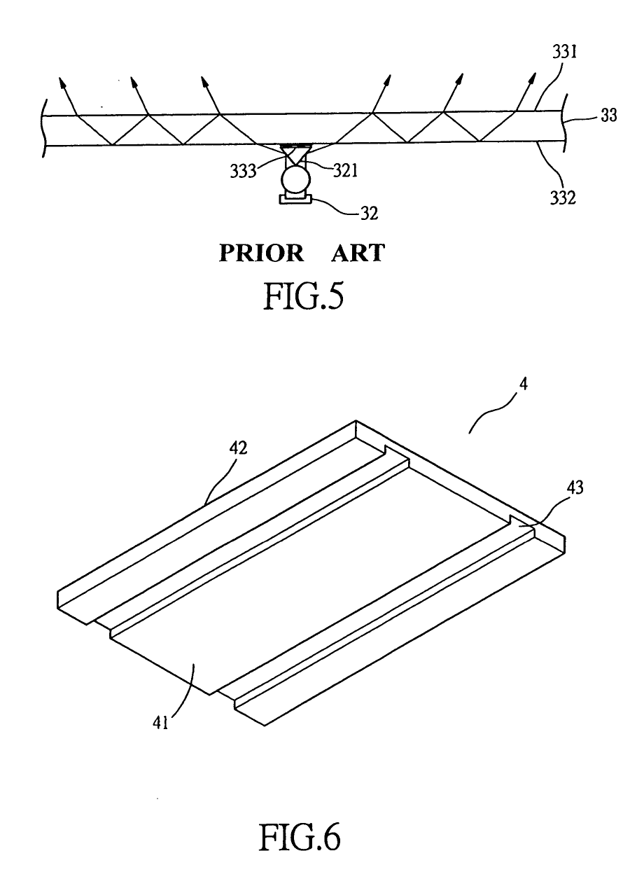

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

As shown in FIG. 6, a light mixing plate 4 according to an embodiment of the present invention, made of a material having a high transparency such as Polymethyl Methacrylate (PMMA), has a first surface 41 and a second surface 42. Along the first surface 41, there are a number of elongated grooves 43 indented into the first surface 41 but not penetrating to the second surface 42. The cross-section of the grooves 43 could have a rectangular or other appropriate shape.

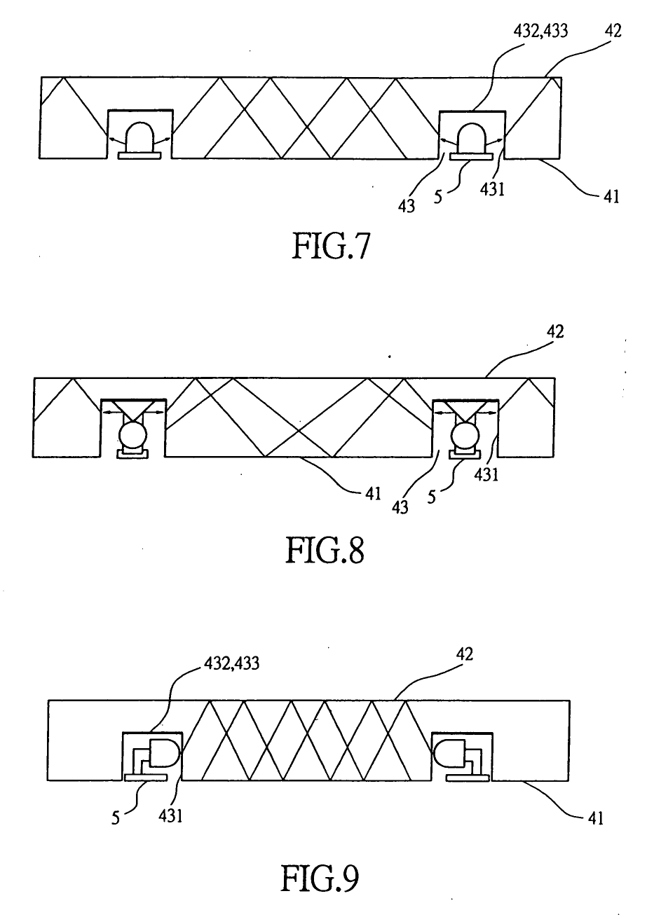

As shown in FIG. 7, each of the grooves 43 accommodates and encloses a number of LEDs 5 and the lights from the LEDs 5 therefore enter the light mixing plate 4 via the inner wall 432 and the side walls 431 of the groove 43. To avoid lights directly penetrate through the inner wall 432, light shielding material could be coated on the inner wall 432 as a light shielding layer 433 corresponding to the locations of the LEDs 5. As such, most of the lights from the LEDs 5 enter the light mixing plate 4 via the side walls 431 of the grooves 43 and propagate along the light mixing plate 4. Since the LEDs 5 are buried inside the body of the light mixing plate 4, the lights from the LEDs 5 could propagate for a longer distance inside the light mixing plate 4, as compared to the conventional approaches where the LEDs are located outside of the light mixing plate. As such, if the LEDs 5 are all white-light LEDs, a more uniform planar light could be achieved. If the LEDs 5 are various colored LEDs, a better mixed white light could be achieved, obviating the incomplete mixing problem of conventional approaches.

As shown in FIG. 8, if the LEDs 5 are side-emitting LEDs, lights from the LEDs 5 are emitted directly to the side walls 431 in a right angle. The lights therefore could travel even farther inside the light mixing plate 4 and the light mixing effect is further enhanced.

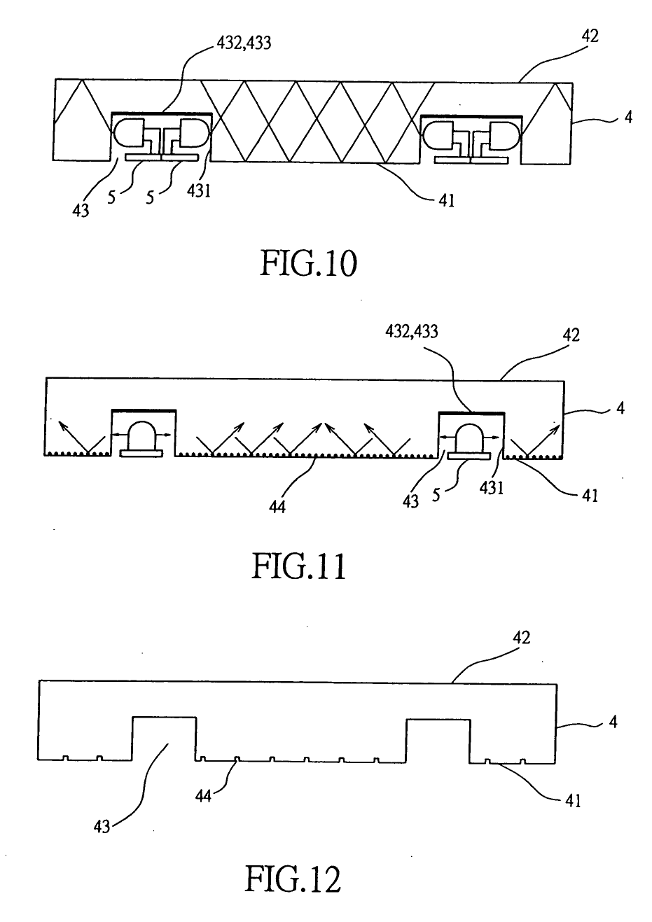

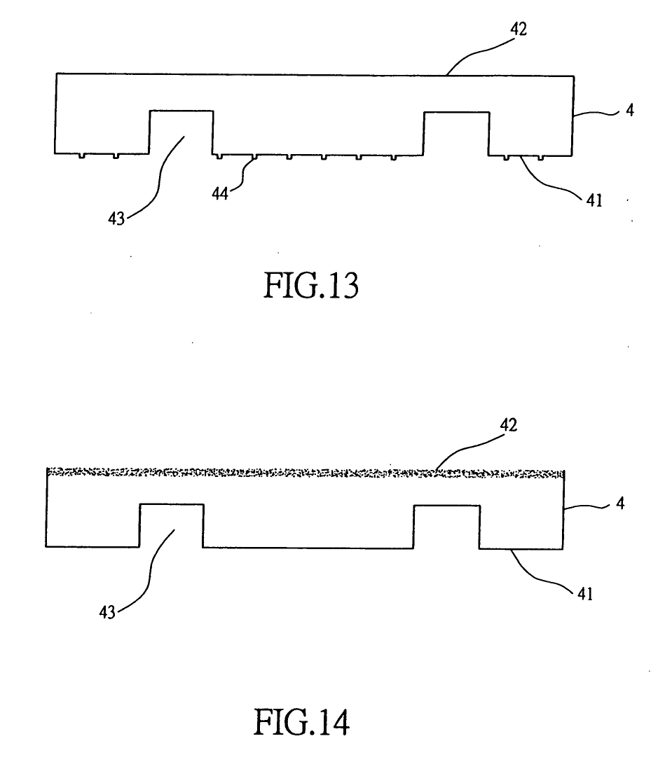

Similarly, as shown in FIGS. 9 and 10, one ore more LEDs 5 could be arranged laterally inside the grooves 43 to achieve an identical result to the previous embodiment using side-emitting LEDs.

As shown in FIG. 11, the first surface 41 of the light mixing plate 4 could have a light guiding pattern 44 containing a number of light guiding dots formed by printing. Or, the light guiding pattern 44 could be a concaved one as shown in FIG. 12 or a bulged one as shown in FIG. 13, when the light mixing plate 4 is molded. When lights reach the light guiding pattern 44, they are reflected and diffused toward the second surface 42 and the lights are thereby uniformed in the process.

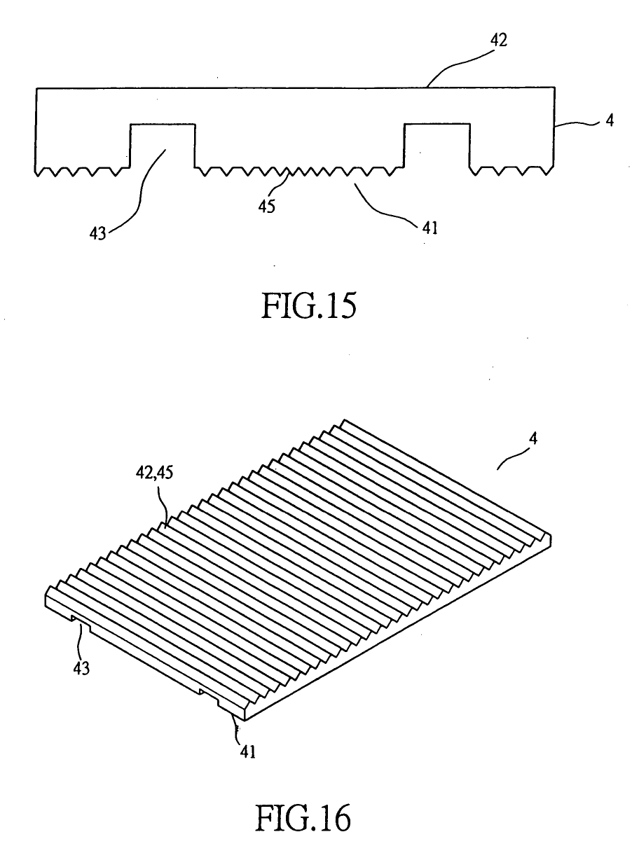

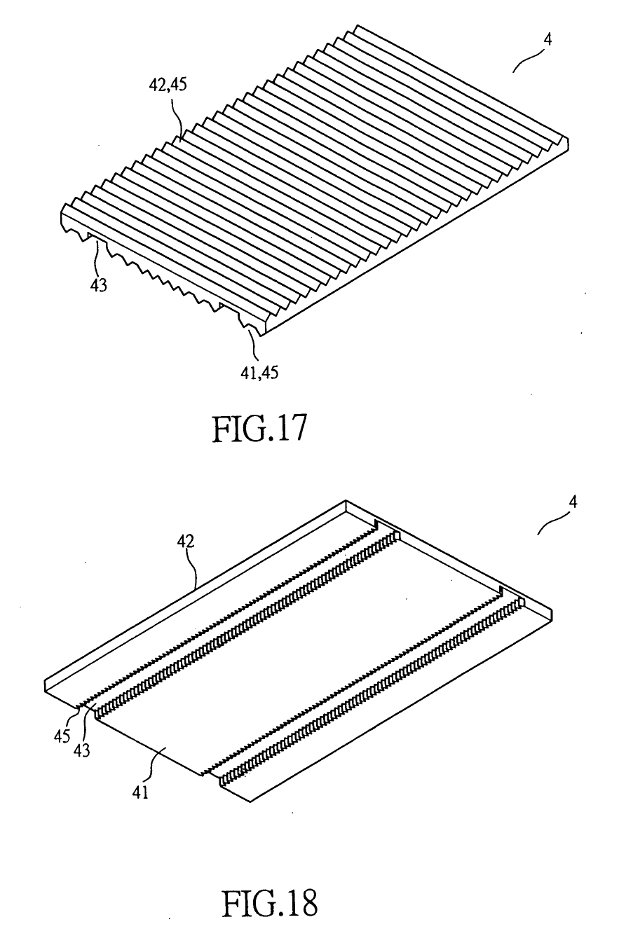

Additionally, the second surface 42 of the light mixing plate 4 could be roughened to become a mat surface, so that, when lights leave the light mixing plate 4 via the second surface 42, they are thereby further diffused. As shown in FIG. 15, the first surface 41 of the light mixing plate 4 could have a number of elongated V-shaped light guiding entities 45 parallel to the grooves 43 so that, when lights reach the first surface 41, they are focused and redirected toward the second surface 42. The focusing effect of the light guiding entities 45 helps improving the brightness of lights from the light mixing plate 4. The light guiding entities 45 could be arranged such that they are denser together as they are farther away from the grooves 43. As the intensity of lights from the LEDs 5 are getting weaker as they travel farther, denser light guiding entities 45 help making up the degraded intensity so that the energy distribution of lights from the light mixing plate 4 could be controlled.

As shown in FIG. 16, the elongated V-shaped light guiding entities 45 could also be configured on the second surface 42 of the light mixing plate 4. As such, after lights are fully mixed inside the light mixing plate 4, their brightness is enhanced by the focusing effect of the V-shaped light guiding entities 45 as the lights leave the light mixing plate 4 via the second surface 42.

As shown in FIG. 17, the V-shaped light guiding entities 45 could be configured simultaneously on the first and the second surfaces 41 and 42. The V-shaped light guiding entities 45 on the two surfaces are arranged such that their orientations are orthogonal to each other. As such, when lights reach the first surface 41, they are reflected to a first direction and, when they reach the second surface, they are focused and refracted out to a second direction. With this multi-directional focusing, the brightness of lights from the light mixing plate 4 is further enhanced.

To further improve the mixing of lights in the light mixing plate 4, the V-shaped light guiding entities 45 could also be configured along the side walls 431 of the grooves 43 as shown in FIG. 18. As such, lights from the LEDs 5 would travel even further inside the light mixing plate 4 to undergo more mixing with other lights.

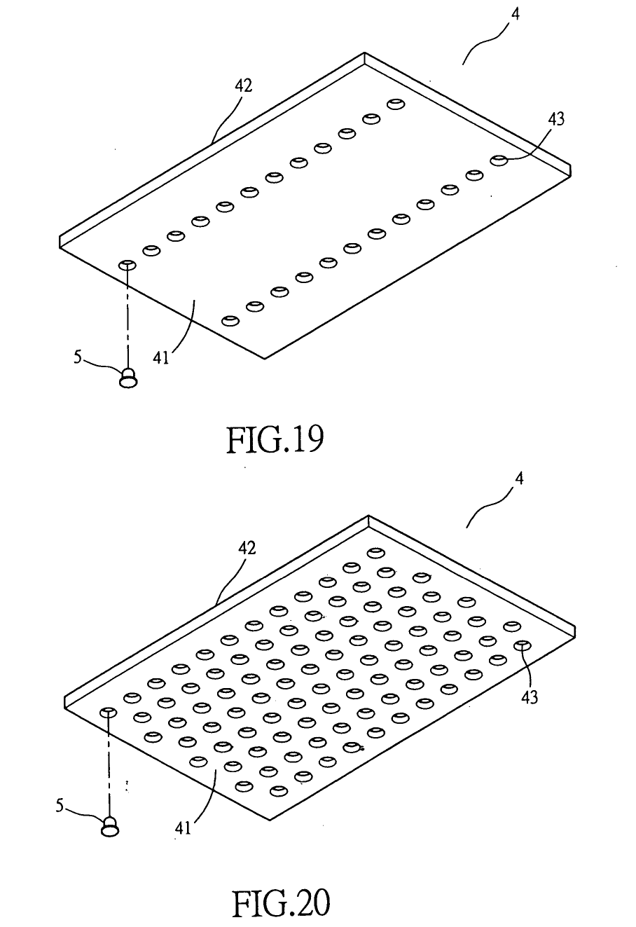

FIG. 19 is a perspective view showing another embodiment of the light mixing plate of the present invention. In this embodiment, the elongated grooves are replaced with circular indented holes 43 arranged in an array or uniformly distributed along the first surface 41 as shown in FIG. 20. Each of the indented holes 43 accommodates a least a LED 5. The inner wall 432 of the hole 43 is also coated with a light shielding layer 433 so that most of the lights from the LED 5 enter the light mixing plate 4 via the side wall 431.

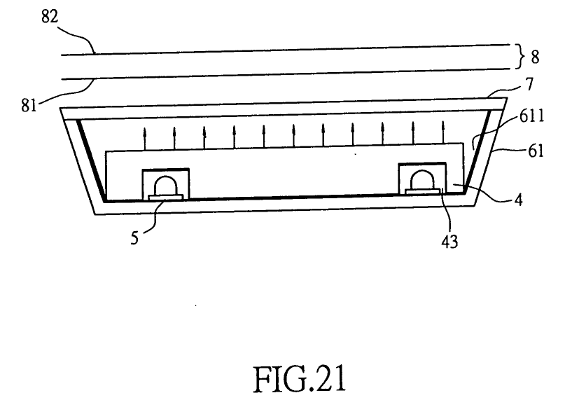

As illustrated in FIG. 21, a LED-based direct backlight module integrating the light mixing plate 4 according to the present invention mainly contains a hollow casing 61 having an opening whose inner surface is coated with a reflection film 611, or is processed to become a reflective surface. A number of LEDs 5 are positioned inside the casing 61 and housed by the grooves 43 of the light mixing plate 4. A diffusion plate 7 and one or more optical sheets 8 are sequentially positioned in front of the light mixing plate 4 along the path of lights from the LEDs 5. The optical sheets 8 could contain one ore more diffusion sheet 81 and prism sheets 82. The number of diffusion and prism sheets 81 and 82, and their relative positions, could be adjusted based on the application requirement.

As such, lights from the LEDs 5 enter the light mixing plate 4 via the side walls 431 of the grooves 43. If the LEDs 5 are white-light LEDs, the lights from the point light sources (i.e., the LEDs 5) could travel an extended distance inside the light mixing plate 4 and thereby are uniformed mixed with each other to achieve a superior planar light when leaving the second surface 42 of the light mixing plate 4. If the LEDs 5 are various colored LEDs, they are fully mixed into a uniform planar while light for subsequent application. As the light mixing plate 4 of the present invention provides a full mixing effect to the lights, the distance between the light mixing plate 4 and the diffusion plate 7 could be significantly narrowed. Together with having the first surface 41 of the light mixing plate 4 joined to the inner surface of the casing 61 and sealing the LEDs 5 inside, a super slim backlight module is thereby achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light mixing plate for a LED direct backlight module comprising a first surface and a second surface, said first surface having a plurality of indentations into said first surface but not penetrating to said second surface.

2. The light mixing plate according to claim 1, wherein each of said indentations is an elongated groove.

3. The light mixing plate according to claim 1, wherein each of said indentations is a circular hole, and said holes are arranged in an array or distributed evenly.

4. The light mixing plate according to claim 2, wherein the inner wall of each of said grooves is partially coated with a light shielding layer.

5. The light mixing plate according to claim 3, wherein the inner wall of each of said holes is partially coated with a light shielding layer.

6. The light mixing plate according to claim 1, wherein said first surface is coated with a light guiding pattern.

7. The light mixing plate according to claim 1, wherein said second surface is roughened to be a mat surface.

8. The light mixing plate according to claim 1, wherein a plurality of elongated V-shaped light guiding entities are configured on said first surface.

9. The light mixing plate according to claim 8, wherein said V-shaped light guiding entities are parallel to said indentations.

10. The light mixing plate according to claim 9, wherein said V-shaped light guiding entities are denser as they are located farther away from said indentations.

11. The light mixing plate according to claim 1, wherein a plurality of elongated V-shaped light guiding entities are configured on said second surface.

12. The light mixing plate according to claim 1, wherein a plurality of elongated V-shaped light guiding entities are configured on said first surface and said second surface respectively.

13. The light mixing plate according to claim 12, wherein the orientation of said V-shaped light guiding entities on said first surface and the orientation of said V-shaped light guiding entities on said second surface are orthogonal.

14. The light mixing plate according to claim 1, wherein a plurality of V-shaped light guiding entities are configured on the side walls of said indentations.

15. A direct backlight module comprising: light mixing plate for a LED direct backlight module comprising:
a hollow casing having an opening and reflective inner surface;
a plurality of LEDs positioned inside said hollow casing;
a light mixing plate having a first surface and a second surface, said first surface having a plurality of indentations into said first surface but not penetrating to said second surface, said light mixing plate covering and housing said LEDs inside said indentations;
a diffusion plate positioned at said opening of said hollow casing;
a plurality of optical sheets positioned behind said diffusion plate along the path of light from said LEDs;
wherein the lights from said LEDs enter said light mixing plate via the side walls of said indentations, and mix with each other as the lights propagate for an extended distance inside said light mixing plate so as to produce a uniform planar light for said backlight module.

16. The direct backlight module according to claim 15, wherein each of said indentations is an elongated groove.

17. The direct backlight module according to claim 15, wherein each of said indentations is a circular hole, and said holes are arranged in an array or distributed evenly.

18. The direct backlight module according to claim 16, wherein the inner wall of each of said grooves is partially coated with a light shielding layer.

19. The direct backlight module according to claim 17, wherein the inner wall of each of said holes is partially coated with a light shielding layer.

20. The direct backlight module according to claim 15, wherein said first surface is coated with a light guiding pattern.

21. The direct backlight module according to claim 15, wherein said second surface is roughened to be a mat surface.

22. The direct backlight module according to claim 15, wherein a plurality of elongated V-shaped light guiding entities are configured on said first surface.

23. The direct backlight module according to claim 22, wherein said V-shaped light guiding entities are parallel to said indentations.

24. The direct backlight module according to claim 23, wherein said V-shaped light guiding entities are denser as they are located farther away from said indentations.

25. The direct backlight module according to claim 15, wherein a plurality of elongated V-shaped light guiding entities are configured on said second surface.

26. The direct backlight module according to claim 15, wherein a plurality of elongated V-shaped light guiding entities are configured on said first surface and said second surface respectively.

27. The direct backlight module according to claim 26, wherein the orientation of said V-shaped light guiding entities on said first surface and the orientation of said V-shaped light guiding entities on said second surface are orthogonal.

28. The direct backlight module according to claim 15, wherein a plurality of V-shaped light guiding entities are configured on the side walls of said indentations.

29. The direct backlight module according to claim 15, wherein said LEDs are white-light LEDs, or comprises red-light, green-light, and blue-light LEDs.

30. The direct backlight module according to claim 29, wherein said LEDs are arranged laterally inside said indentations so that said LEDs face the side walls of said indentations.

31. The direct backlight module according to claim 29, wherein said LEDs are side-emitting LEDs.

32. The direct backlight module according to claim 15, wherein the inner surface of said hollow casing is coated with a reflection film.

33. The direct backlight module according to claim 15, wherein said first surface of said light mixing plate is joined to the inner surface of said hollow casing.

34. The direct backlight module according to claim 15, wherein said optical sheets comprise at least one of the following: diffusion sheet and prism sheet.
